(19) United States
(12) Patent Application Publication
(10) Pub. No.: US 2012/0307190 A1
(43) Pub. Date: Dec. 6, 2012

(54) Pixel Electrode And Liquid Crystal Display Array Substrate

(75) Inventor: Xin Zhang, Shenzhen City (CN)

(73) Assignee: SHANGHAI TIANMA MICRO-ELECTRONICS CO., LTD., Shanghai City (CN)

(21) Appl. No.: 13/381,887

(22) PCT Filed: Sep. 29, 2011
(86) PCT No.: PCT/CN2011/080349

§ 371 Date: Dec. 30, 2011

(30) Foreign Application Priority Data
Jun. 3, 2011 (CN) 2011101487196

(51) Int. Cl. G02F 1/1343

(52) U.S. Cl. 349/142

(57) ABSTRACT

The present invention discloses a pixel electrode including four portions each including strip-like branches and a liquid crystal display array substrate. Adjacent strip-like branches are spaced by a slit. The strip-like branches extend outward from the central zone; wherein the strip-like branches of the four portions are connected to each other at locations where they are adjacent to each other to form an alternately-jointed section extending in vertical direction and an alternately-jointed section extending in horizontal direction with all the strip-like branches being in electrical conduction with each other. Practicing the present invention allows main trunks used in the structure of the pixel electrode to be removed so as to provide increased opening rate. The strip-like branches of the four portions at locations where they are adjacent to each other are arranged in an alternate manner to effectively suppress the occurrence of phenomenon of “disclination lines” at such locations.

### CROSS REFERENCES TO RELATED APPLICATIONS

This application claims the priority of Chinese Patent Application No. 201110148719.6, of which the title is “Pixel Electrode and Liquid Crystal Display Array Substrate”, filed with Chinese Patent Office on Jun. 3, 2011, which, in its entirety is hereby incorporated for reference.

### BACKGROUND OF THE INVENTION

1. Field of the Invention

The present invention relates to the field of liquid crystal displaying techniques, and in particular to a pixel electrode and liquid crystal display array substrate.

2. The Related Arts

Liquid crystal displays (LCDs) are one of the most commonly used flat panel displays. An LCD comprises a pair of substrates that are provided with field generating electrodes, such as pixel electrode and common electrode, and a liquid crystal (LC) layer interposed between the two substrates. When a voltage is applied to the field generating electrode to induce an electric field in the LC layer, the electric field determines the orientation of the LC molecules of the liquid crystal layer so as to adjust the polarization of the light incident to the liquid crystal layer to allow an image to be displayed by the LCD.

A so-called polymer stabilized vertical alignment (PSVA) technique has been developed in the industry and such a technique mixes monomer of a suitable concentration in a liquid crystal material and uniformly shakes. Afterwards, the mixed liquid crystal material is positioned in a heater to be heated until reaching a condition of isotropy. When the liquid crystal mixture is cooled down to the room temperature, the liquid crystal mixture returns to a nematic condition. Afterwards, the liquid crystal mixture is filled into a liquid crystal box and is subject to application of voltage. When the applied voltage makes the arrangement of liquid crystal molecules stable, the monomer is caused to perform polymerization by means of ultraviolet radiation or heating in order to form a polymer layer, so as to achieve the purpose of alignment stabilization.

A liquid crystal display device generally comprises a backlight module, first and second substrates that oppose each other, and a layer of liquid crystal filled between the two substrates. The second substrate is provided with a pixel electrode. As shown in FIG. 1, a schematic view of a unit pixel electrode structure used in a liquid crystal display panel 100 according to a known technique is shown. As shown in FIG. 1, the liquid crystal display panel comprises a data line DL, a scan line SL, a thin film transistor 114, and a pixel electrode 110. The pixel electrode 110 is located in a pixel area and shows a snow flake like layout. The pixel electrode 110 is composed of three portions, including a vertical central main trunk 111, a horizontal central main trunk 112, and branches 113 that include an angle of ±45 degrees or ±135 degrees with respect to the X-axis. The vertical main trunk 111 and the horizontal main trunk 112 equally divide the pixel area into four domains and each domain is formed by laying flat the branches 113 of 45 degree inclination.

Each of the strip-like branches is located on the same plane as the vertical main trunk and the horizontal main trunk. The vertical main trunk and the horizontal main trunk centrally and perpendicularly intersect each other. The term “central perpendicular intersection” as used herein refers to the vertical main trunk and the horizontal main trunk being perpendicular to each other and an area around a center of the perpendicular intersection being a central zone of the unit pixel electrode, the vertical main trunk and the horizontal main trunk equally dividing the whole pixel area of the pixel into four domains, each domain being formed of flat-laying strip-like branches that show predetermined angles with respect to the vertical main trunk or the horizontal main trunk. In this way, an arrangement of snow flake like electrode that is of mirror symmetry in up-down direction and left-right direction is formed as shown in FIG. 1. Some of the branches 113 are electrically connected to the transistor 114 to transmit a voltage from the data line DL to the pixel electrode. Orientation of liquid crystal in a cross-section taken along phantom lines A-B-C of FIG. 1 is illustrated in FIG. 3.

FIG. 2 is a schematic view illustrating inclination of liquid crystal with a voltage (around 0 to 4V, arrow indicating the application of voltage) applied to the structure of pixel electrode shown in FIG. 1. As shown in FIG. 2, when a snow flake like pixel electrode is energized, the orientation of liquid crystal is gradually inclined from outside of the pixel electrode 110 toward inside and the angle of inclination is along the direction of the branches. The inclination directions of the liquid crystals in the four domains are respectively ±45 degrees and ±135 degrees and all point to a central zone of the pixel. The angles of the orientations of liquid crystal of the four domains with respect to the x axis (the scan line) are: −135 degrees for the first quadrant, −45 degrees for the second quadrant, 45 degrees for the third quadrant, and 135 degrees for the fourth quadrant.

As shown in FIG. 3, a schematic view illustrating orientation of liquid crystal in the cross-section taken along the phantom lines A-B-C of FIG. 1 is shown. Within the cross-section (which is a cross-section normal to the surface of paper sheet) at the location of the phantom lines of FIG. 1, the angles of inclination of liquid crystal is gradually inclined from outside toward inside, pointing inward of the pixel.

For the known technique, the pixel electrode 110 heavily relies on the central vertical main trunk 111 and the horizontal main trunk 112. However, the main trunks 111, 112 are basically light-blocked areas. This is because the liquid crystals within the main trunks 111/112 are oriented along the directions of the main trunks, which respectively include an angle of 0 degree and 90 degrees with respect to the x axis, while upper and lower polarization plates are set to respectively include an angle of 0 degree and 90 degrees with respect to the x axis. Consequently, it can be found from the transmittance formula that the transmittance at the main trunks is null. Further, since the regions of the main trunks occupy a great area, such an arrangement reduces opening rate of the liquid crystal display panel.

Further, since the directions of the liquid crystals within the main trunks include an angle of 0 degree and 90 degrees with respect to the x axis, which is different from the direction of the branches, it is very easy to generate disclination lines, as shown in FIGS. 4 and 5, in which FIG. 4 shows a result of simulation and FIG. 5 is a microscopic photo of an experimental product.

### SUMMARY OF THE INVENTION

The technical issue that embodiments of the present invention intend to address is to provide a pixel electrode and a liquid crystal display array substrate.

Embodiments of the present invention provide a pixel electrode. The pixel electrode comprises four portions that are formed by dividing a central zone along horizontal and vertical directions, the four portions each comprising a plurality of strip-like branches, adjacent ones of the plurality of strip-like branches being spaced by a slit, the plurality of strip-like branches extending outward from the central zone;

wherein the strip-like branches of the four portions are connected to each other at locations where they are adjacent to each other to form an alternately-jointed section extending in vertical direction and an alternately-jointed section extending in horizontal direction with all the strip-like branches being in electrical conduction with each other.

Correspondingly, embodiments of the present invention also provide a liquid crystal display array substrate. The liquid crystal display array substrate comprises a plurality of pixel electrodes. The pixel electrodes each comprise:

four portions that are formed by dividing a central zone along horizontal and vertical directions, the four portions each comprising a plurality of strip-like branches, adjacent ones of the plurality of strip-like branches being spaced by a slit, the plurality of strip-like branches extending outward from the central zone;

wherein the strip-like branches of the four portions are connected to each other at locations where they are adjacent to each other to form an alternately-jointed section extending in vertical direction and an alternately-jointed section extending in horizontal direction with all the strip-like branches being in electrical conduction with each other.

Wherein, in the above embodiments, the strip-like branches form an angle of 45 degrees with respect to horizontal direction and vertical direction.

In the alternately-jointed section of the vertical direction, except topmost and bottommost strip-like branches, all remaining strip-like branches that extend to the central zone in vertical direction satisfy that an end of a left-side strip-like branch is jointed to a non-end portion of a right-side strip-like branch and an end of the right-side strip-like branch is jointed to a non-end portion of another left-side strip-like branch; and

in the alternately-jointed section of the horizontal direction, except leftmost and rightmost strip-like branches, all remaining strip-like branches that extend to the central zone in horizontal direction satisfy that an end of an top-side strip-like branch is jointed to a non-end portion of a bottom-side strip-like branch and an end of the bottom-side strip-like branch is jointed to a non-end portion of another top-side strip-like branch.

An alternating width of the alternately-jointed configuration between the strip-like branches is greater than or equal to width of the strip-like branches.

Further, an alternating width of the alternately-jointed configuration between the strip-like branches is identical or different.

The pixel electrode further comprises an electrode loop that surrounds the four portions and connected to each of the strip-like branches.

The mode of the liquid crystal panel is vertical alignment mode.

The material of the pixel electrode of the pixel electrode structure is selectively indium tin oxide, indium zinc oxide, or amorphous indium tin oxide.

Through the adoption of the embodiments of the present invention, the main trunks used in the existing pixel electrodes are removed to allow the strip-like branches to connect at a central zone through alternate arrangement. Due to the omission of the central main trunks, the area of the central “cruciform” black zone is minimized, to thereby provide increased opening rate and suppress the occurrence of disclination lines.

### BRIEF DESCRIPTION OF THE DRAWINGS

To more clearly describe the technical solution of the embodiments according to the present invention or the prior techniques, a brief description of the drawings that are necessary for the illustration of the embodiments or the prior art will be given as follows. Apparently, the drawings described below show only example embodiments of the present invention and for those having ordinary skills in the art, other drawings may be easily obtained from these drawings without paying any creative effort.

FIG. 1 is a schematic view showing a unit pixel electrode structure of a conventional PSVA (Polymer Stabilization Vertical Alignment) mode LCD (Liquid Crystal Display);

FIG. 2 is a schematic view illustrating orientation of liquid crystal with a voltage applied to the pixel electrode shown in FIG. 1;

FIG. 3 is a schematic view illustrating orientation of liquid crystal within a cross-section taken along phantom lines of FIG. 1;

FIG. 4 is a schematic view illustrating a result of simulation showing disclination lines caused by central main trunks;

FIG. 5 is a schematic view illustrating a microscopic photo of an experimental product manufacturing according to the known technique, showing the disclination lines caused by the central main trunks;

FIG. 6 is a schematic view illustrating a pixel electrode according to a first embodiment of the present invention;

FIG. 7 is a schematic view illustrating details of the pixel electrode of FIG. 6;

FIG. 8 is a schematic view illustrating structure details of a pixel electrode according to a second embodiment of the present invention; and

FIG. 9 is a schematic view illustrating a pixel electrode according to a third embodiment of the present invention.

### DETAILED DESCRIPTION OF THE PREFERRED EMBODIMENTS

Technical solutions provided in embodiments of the present invention will be described as follows in a clear and complete manner with reference to the embodiments of the present invention and the drawings. However, it is apparent that the embodiments described herein are just a few, not all, of the embodiments available to the present invention. Ordinary skilled persons of this field may obtain various embodiments without putting in creative efforts, which are all considered within the protection scope of the present invention.

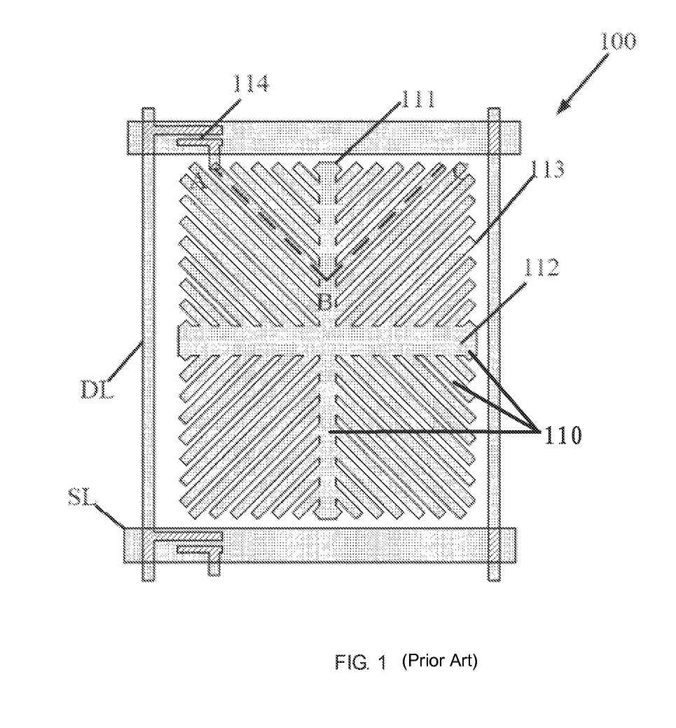

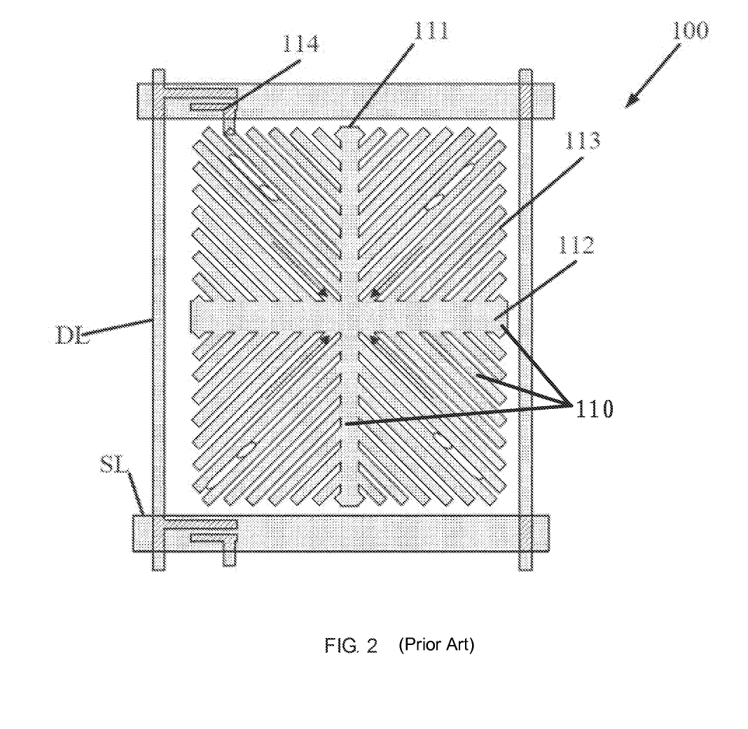

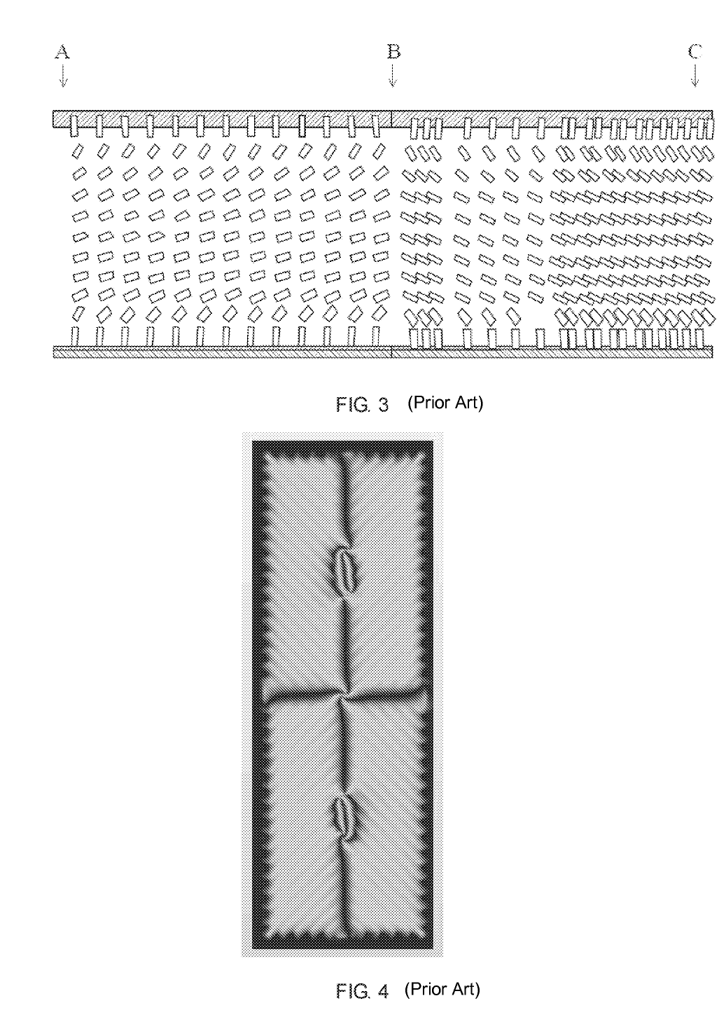

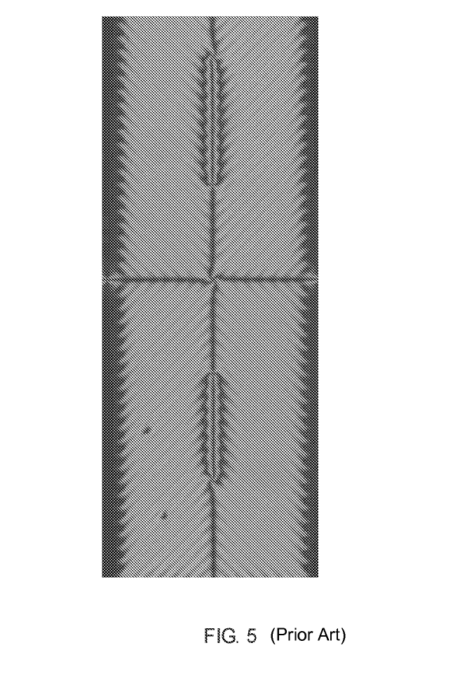

A PSVA (Polymer Stabilization Vertical Alignment) pixel electrode according to the known techniques is of a snow flake like configuration, namely the shaded area of FIG. 1 (the area with indium tin oxide, ITO) showing a snow flake like configuration. With a voltage applied, liquid crystals incline toward the inside of the pixel electrode in the directions of strips of the pixel electrode. Consequently, two main trunks, one being horizontal and one vertical, are needed at a center of the pixel electrode and they are not an opening region. Such a region occupies a great area. (The whole pixel is completely filled with liquid crystal, whether it is a light-transmitting area or a light-blocked area, the difference being that the orientations of liquid crystals being different with a voltage applied thereto.)

In an embodiment of the present invention, the main trunk is removed from the pixel electrode, and the branches are connected at a central zone through an alternating arrangement. Certainly, the central zone of the pixel electrode does not need to be strictly uniform alternate arrangement in up-down direction and it only requires all the branches are in electrical conduction with each other. Due to such an arrangement free of central main trunks, the area of the central “cruciform” dark zone is minimized, allowing it to provide an increased opening rate and suppress the occurrence of disclination lines.

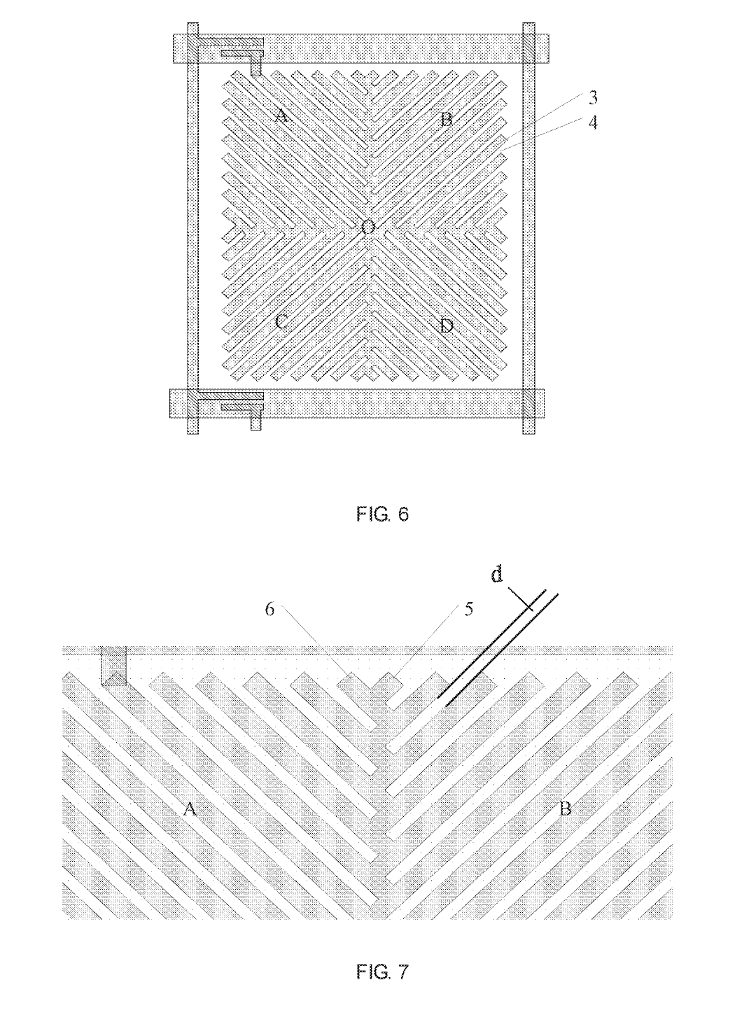

As shown in FIG. 6, which is a schematic view illustrating a structure of pixel electrode according to a first embodiment of the present invention.

The pixel electrode comprises four portions (the four domains A, B, C, and D shown in the drawings) that are formed by dividing a central zone along a horizontal direction and a vertical direction. The four portions each comprise a plurality of strip-like branches. Adjacent ones of the plurality of strip-like branches are spaced by a slit. The plurality of strip-like branches extends outward with respect to the central zone. For example, in FIG. 6, a strip-like branch 3 is spaced from a lower next branch by a slit 4.

In the example shown in FIG. 6, the strip-like branches of the four portions A, B, C, and D can be parallel to each other and the strip-like branches form an angle of 45 degrees with respect to the horizontal direction and the vertical direction. Other angles are also feasible. For example, the strip-like branches 3 of domain B are set at an angle of 30 degrees with respect to the horizontal direction and in domain A, the strip-like branches 3 are at an angle of 150 degrees with respect to the horizontal direction. In this way, the strip-like branches of domain A and domain B are made symmetric with respect to a vertical direction extending through a central point O. Similarly, the directions of the branches of domain C and domain D can be set in a corresponding manner to have domain A and domain C, and domain B and domain D, symmetric with respect a horizontal direction extending through the central point O, and the strip-like branches of domain C and domain D are made symmetric with respect to the vertical direction extending through the central point O.

Alternatively, the strip-like branches of the four portions A, B, C, and D can be made not parallel. In other words, adjacent ones of the strip-like branches of one of the portions are spaced by an angle therebetween. This angle can be of a size that is determined according to the need of design or the actually applied manufacturing technology.

The strip-like branches of the four portions are connected to each other at the locations where they are adjacent to each other to form an alternately-jointed section extending in vertical direction and an alternately-jointed section extending in horizontal direction with all the strip-like branches being in electrical conduction with each other.

For example, in the alternately-jointed section of the vertical direction, except the topmost and bottommost strip-like branches, all the remaining strip-like branches that extend to the central zone in vertical direction satisfy that an end of a left-side strip-like branch is jointed to a non-end portion of a right-side strip-like branch and an end of the right-side strip-like branch is jointed to a non-end portion of another left-side strip-like branch.

In the alternately-jointed section of the horizontal direction, except the leftmost and rightmost strip-like branches, all the remaining strip-like branches that extend to the central zone in horizontal direction satisfy that an end of an top-side strip-like branch is jointed to a non-end portion of a bottom-side strip-like branch and an end of the bottom-side strip-like branch is jointed to a non-end portion of another top-side strip-like branch.

Namely, as shown in FIG. 6, a cruciform structure formed by the alternately-jointed section of the horizontal direction and the alternately-jointed section of the vertical direction has a vertical bar, which has left and right sides containing strip-like branches that are alternate with each other in the vertical direction to form a joint of “y”-shaped configuration with the left stroke of an upper “y” located above the right stroke of a lower “y”, and a horizontal bar, which has top and bottom sides containing strip-like branches that are alternate with each other to form a joint of 90-degree rightward rotated “y”-shaped configuration, so that all the strip-like branches are in electrical conduction with each other.

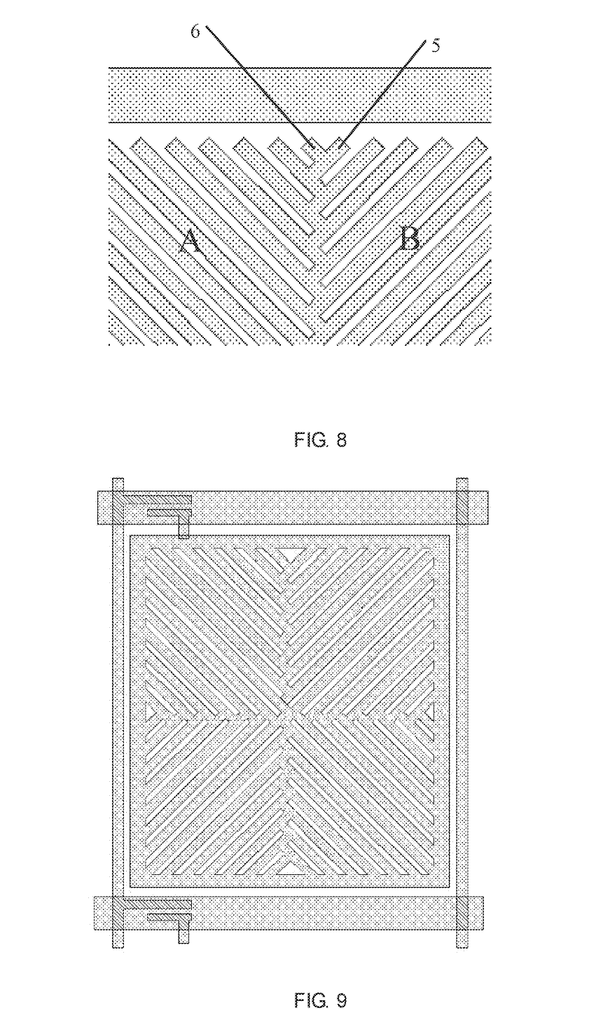

As shown in FIG. 7, a schematic view illustrating details of the pixel electrode of FIG. 6 is shown. In the embodiment illustrated in Figures 6 and 7, for the jointed strip-like branches of domain A and domain B, the strip-like branches 5 of domain B are located on the right upper side of the strip-like branches 6 of domain A, but they can be reversed in other embodiments of the present invention, as shown in FIG. 8. In the example shown in FIG. 8, the strip-like branches 5 of domain B are located on the right lower side of the strip-like branches 6 of domain A. Certainly, in other embodiments of the present invention, the angle of the strip-like branches can be other angles different from the 45 degree angle of the alternating strip-like branches shown in FIGS. 7 and 8.

Further, as shown in FIG. 7, the alternating width between the strip-like branches 3 can be of various settings. (For identical strip-like branches, the corresponding alternating width d is equal to the width of the corresponding slits 4.) For example, the alternating width of the alternately-jointed configuration between the strip-like branches can be greater than or equal to the width of the strip-like branches. Also, the alternating width of the alternately-jointed configuration between the strip-like branches can be identical or different. For example, if the spacing distances between the strip-like branches are different, the alternating width can be set in accordance with the variable spacing distances of the strip-like branches. Such a flexible selection of alternating width is associated with the gap between adjacent strip-like branches and based on the need of actual design and requirement for manufacturing techniques, different ratios can be set between the gap between the adjacent strip-like branches and the width of the strip-like branches and between different gaps of adjacent strip-like branches, so as to effect corresponding adjustment of the alternating width.

In the examples shown in FIGS. 6-8, all the strip-like branches are of the same width. Based on the need of actual design and the requirement of technique, different ones of the strip-like branches can be of different widths. A single strip-like branch may be of variable width by itself, such as a strip-like branch in the form of a sector.

As shown in FIG. 9, a schematic view illustrating a structure of pixel electrode according to a third embodiment of the present invention is shown. A difference from the previous two embodiments is that in the instant example, the strip-like electrode comprises a loop of electrode extending along an outer circumference thereof and connected to each of the strip-like branches. The thin film transistor is connected to that portion of the electrode. This structure makes the overall structure of the pixel electrode more concrete and showing improved conductivity.

Further, the mode of the above discussed liquid crystal panel can be polymer stabilization vertical alignment (PSVA) mode. The material that makes the pixel electrode of the above discussed pixel electrode structure can be indium tin oxide, indium zinc oxide, or amorphous indium tin oxide.

Correspondingly, an embodiment of the present invention also provides a liquid crystal display array substrate, which comprises a plurality of the above-discussed pixel electrodes.

Through the adoption of the embodiments of the present invention, the main trunks used in the existing pixel electrodes are removed to allow the branches to connect at a central zone through alternate arrangement. Due to the omission of the central main trunks, the area of the central “cruciform” black zone is minimized, to thereby provide increased opening rate and suppress the occurrence of disclination lines.

The description given above is a preferred embodiment of the present invention and it is not intended to limit the scope of right of the present invention thereto. Thus, equivalent variations made according to the appended claims of the present invention are considered within the scope of the present invention.

1. A pixel electrode, wherein the pixel electrode comprises four portions that are formed by dividing a central zone along horizontal and vertical directions, the four portions each comprising a plurality of strip-like branches, adjacent ones of the plurality of strip-like branches being spaced by a slit, the plurality of strip-like branches extending outward from the central zone;
wherein the strip-like branches of the four portions are connected to each other at locations where they are adjacent to each other to form an alternately jointed section extending in the vertical direction and an alternately jointed section extending in the horizontal direction with all the strip-like branches being in electrical conduction with each other.

2. The pixel electrode as claimed in claim 1, wherein the strip-like branches form an angle of 45 degrees with respect to the horizontal direction and vertical direction.

3. The pixel electrode as claimed in claim 1, wherein the alternately jointed section of the vertical direction, except topmost and bottommost strip-like branches, all remaining strip-like branches that extend to the central zone in the vertical direction satisfy that an end of a left-side strip-like branch is jointed to a non-end portion of a right-side strip-like branch and an end of the right-side strip-like branch is jointed to a non-end portion of another left-side strip-like branch; and
in the alternately jointed section of the horizontal direction, except leftmost and rightmost strip-like branches, all remaining strip-like branches that extend to the central zone in the horizontal direction satisfy that an end of an top-side strip-like branch is jointed to a non-end portion of a bottom-side strip-like branch and an end of the bottom-side strip-like branch is jointed to a non-end portion of another top-side strip-like branch.

4. The pixel electrode as claimed in claim 1, wherein an alternating width of the alternately jointed configuration between the strip-like branches is greater than or equal to width of the strip-like branches.

5. The pixel electrode as claimed in claim 1, wherein an alternating width of the alternately jointed configuration between the strip-like branches is identical or different.

6. The pixel electrode as claimed in claim 1, wherein the pixel electrode further comprises an electrode loop that surrounds the four portions and connected to each of the strip-like branches.

7. The pixel electrode as claimed in claim 1, wherein a mode of a liquid crystal panel having the pixel electrode is a vertical alignment mode.

8. The pixel electrode as claimed in claim 1, wherein material of the pixel electrode is selectively indium tin oxide, indium zinc oxide, or amorphous indium tin oxide.

9. A liquid crystal display array substrate, wherein the liquid crystal display array substrate comprises a plurality of pixel electrodes, the pixel electrodes each comprising:
four portions that are formed by dividing a central zone along horizontal and vertical directions, the four portions each comprising a plurality of strip-like branches, adjacent ones of the plurality of strip-like branches being spaced by a slit, the plurality of strip-like branches extending outward from the central zone;
wherein the strip-like branches of the four portions are connected to each other at locations where they are adjacent to each other to form an alternately jointed section extending in the vertical direction and an alternately jointed section extending in the horizontal direction with all the strip-like branches being in electrical conduction with each other.

10. The liquid crystal display array substrate as claimed in claim 9, wherein the strip-like branches form an angle of 45 degrees with respect to the horizontal direction and vertical direction.

11. The liquid crystal display array substrate as claimed in claim 9, wherein the alternately jointed section of the vertical direction, except topmost and bottommost strip-like branches, all remaining strip-like branches that extend to the central zone in the vertical direction satisfy that an end of a left-side strip-like branch is jointed to a non-end portion of a right-side strip-like branch and an end of the right-side strip-like branch is jointed to a non-end portion of another left-side strip-like branch; and
in the alternately jointed section of the horizontal direction, except leftmost and rightmost strip-like branches, all remaining strip-like branches that extend to the central zone in the horizontal direction satisfy that an end of an top-side strip-like branch is jointed to a non-end portion of a bottom-side strip-like branch and an end of the bottom-side strip-like branch is jointed to a non-end portion of another top-side strip-like branch.
